(19) United States
(12) Patent Application Publication
(10) Pub. No.: US 2023/0030514 A1
(43) Pub. Date: Feb. 2, 2023

(54) CLINIC TABLE

(71) Applicant: Body Temper Iowa LLC, Bondurant, IA (US)

(72) Inventor: Matthew Dale Sillanpaa, Bondurant, IA (US)

(21) Appl. No.: 17/879,078

(22) Filed: Aug. 2, 2022

Related U.S. Application Data
(60) Provisional application No. 63/228,336, filed on Aug. 2, 2021.

(51) Int. Cl. A61G 13/00; A61G 13/12; A61H 1/02; A61H 15/00

(52) U.S. Cl. CPC A61G 13/009; A61G 13/1235; A61H 1/02; A61G 13/1285; A61H 15/0092; A61H 2203/0468; A61H 2201/0138; A61H 2015/0014

(57) ABSTRACT

A tempering table is disclosed. The tempering table includes a base structure and a top surface located atop the base structure. The top surface comprises a body portion and a plurality of receiving holes. At least a first receiving hole of the plurality of receiving holes is located on a first side of the body portion, and at least a second receiving hole of the plurality of receiving holes is located on a second side of the body portion opposite the first side of the body portion. The first receiving hole and the second receiving hole are at least approximately symmetrical across a center line of the body portion between the first side of the body portion and the second side of the body portion.

This application claims the benefit of U.S. Provisional Application No. 63/228,336, filed Aug. 2, 2021, the entire contents of which are incorporated herein.

### TECHNICAL FIELD

The disclosure relates to body tempering tables.

### BACKGROUND

A new technique for relieving muscle tension called tempering involves placing weighted tools on the body. Although commonly lumped into mainstream therapeutic practices like massage therapy, chiropractic, physical therapy, and athletic training, tempering and its use of weighted tools make it unique to any offering currently available. The tempering practitioner is responsible for lifting one or more tools, sometimes more than 100 pounds, and safely placing the tools onto the patient. The body part being tempered, the size and shape of the patient, the size and ability of the practitioner, and the weights being used generally cause a typical solid, flat table to be inadequate for proper tempering. Because of this, no suitable table exists for tempering to be performed at peak safety and effectiveness.

For years, tempering has been performed on a variety of repurposed tables, beds, and exercise mats, few of which offer a safe and productive working height. Depending on the body part being tempered, patients are forced to either climb up onto a table or lay down on the floor for tools to be applied. For the purpose of this disclosure, the “tools” include the weighted cylindrical tools utilized in the tempering process. Weighted cylindrical tools rest motionless on the body for minutes at a time. If left unattended, the tools can shift and roll. Practitioners are required to either stand and hold these weighted cylinders which leads to fatigue, or balance the weighted cylinders against secondary, unstable objects. Practitioners constantly find themselves at the mercy of the table they are working with, both in height and weight capacity.

### SUMMARY

In one example, the disclosure is directed to a tempering table that includes a base portion and a top surface. The top surface includes a body portion and a plurality of receiving holes. At least a first receiving hole of the plurality of receiving holes is located on a first side of the body portion, and at least a second receiving hole of the plurality of receiving holes is located on a second side of the body portion opposite the first side of the body portion. The first receiving hole and the second receiving hole are at least approximately symmetrical across a center line of the body portion between the first side of the body portion and the second side of the body portion.

In another example, the disclosure is directed to a method for treating a patient using a tempering table. The method includes positioning a patient on a top surface of a tempering table. The method further includes determining a therapy location on the patient. The method also includes placing a first stable stop into a first receiving hole of the tempering table on a first side of the therapy location on the patient. The method further includes placing a second stable stop into a second receiving hole of the tempering table on a second side of the therapy location on the patient. The method also includes placing a weighted roller onto the patient such that the first stable stop and the second stable stop keep the weighted roller in a stationary location without human assistance.

The clinic table (also referred to as “the tempering table”) of this disclosure is extremely versatile. The clinic table constructed in accordance with this disclosure allows practitioners to deliver the full potential of tempering with a safe, professional, user-friendly design. The clinic table described herein may be height adjustable, such as with the push of a button or other height adjustment mechanism. The tempering table described herein may be comfortable for the patient to lay on, so the patient's head, neck, and arm positions are not compromised. The table described herein also offers support for the rollers (e.g., tempering roller 20 of FIG. 4) and equipment being used in the tempering process. The tempering table described herein grants the practitioner the ability to safely let go of rollers (e.g., tempering roller 20 of FIG. 4), meaning the practitioner may be able to do secondary work on the patient without fear of unattended equipment sliding out of position. The table described herein also gives users the ability to attach straps and resistance bands to help position patients on the table for ideal tempering. Additionally, the table described herein may be capable of receiving different attachments so the patient could lie in a variety of positions, allowing for safe and effective tempering. The examples of this disclosure describe a clinic table that provides a working surface that maximizes all of the unique properties of tempering.

The details of one or more examples of the disclosure are set forth in the accompanying drawings and the description below. Other features, objects, and advantages of the disclosure will be apparent from the description and drawings, and from the claims.

### BRIEF DESCRIPTION OF DRAWINGS

The following drawings are illustrative of particular examples of the present disclosure and therefore do not limit the scope of the invention. The drawings are not necessarily to scale, though examples can include the scale illustrated, and are intended for use in conjunction with the explanations in the following detailed description wherein like reference characters denote like elements. Examples of the present disclosure will hereinafter be described in conjunction with the appended drawings.

FIG. 1 is a schematic diagram illustrating an example tempering table constructed in accordance with this disclosure.

FIG. 2 is a top view of a tempering table with example table stops in accordance with this disclosure.

FIG. 3 is a schematic diagram illustrating options for example table stops in accordance with this disclosure.

FIG. 4 is a schematic diagram illustrating table stops holding a roller in place in accordance with this disclosure.

FIG. 5 is a use diagram illustrating a tempering table while in use with a patient, the tempering table constructed in accordance with this disclosure.

FIG. 6 is a flow diagram illustrating a method for using a tempering table in accordance with this disclosure.

### DETAILED DESCRIPTION

The following detailed description is exemplary in nature and is not intended to limit the scope, applicability, or configuration of the techniques or systems described herein in any way. Rather, the following description provides some practical illustrations for implementing examples of the techniques or systems described herein. Those skilled in the art will recognize that many of the noted examples have a variety of suitable alternatives.

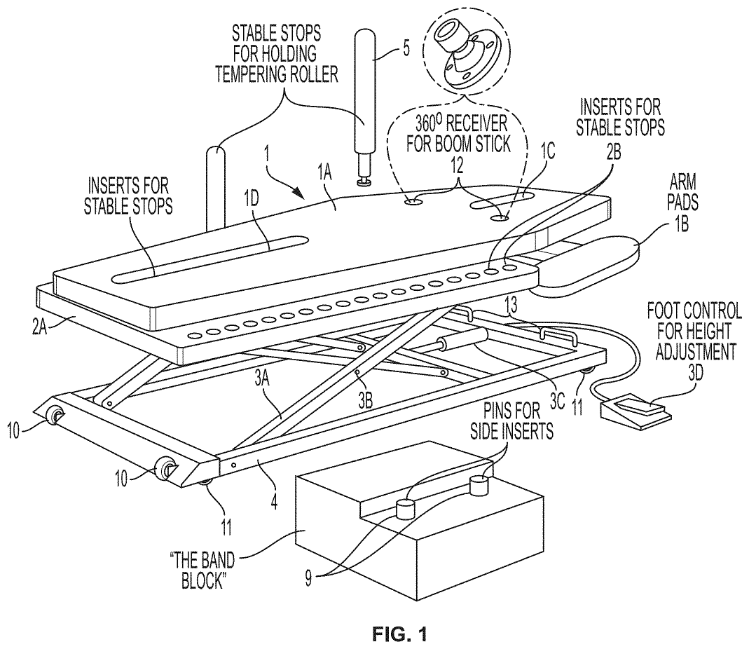

In general example, the disclosure is directed to a tempering table that includes a base portion and a top surface. The top surface includes a body portion and a plurality of receiving holes. At least a first receiving hole of the plurality of receiving holes is located on a first side of the body portion, and at least a second receiving hole of the plurality of receiving holes is located on a second side of the body portion opposite the first side of the body portion. The first receiving hole and the second receiving hole are at least approximately symmetrical across a center line of the body portion between the first side of the body portion and the second side of the body portion. The various components of the tempering table will be described below with respect to the accompanying FIGS. 1-6.

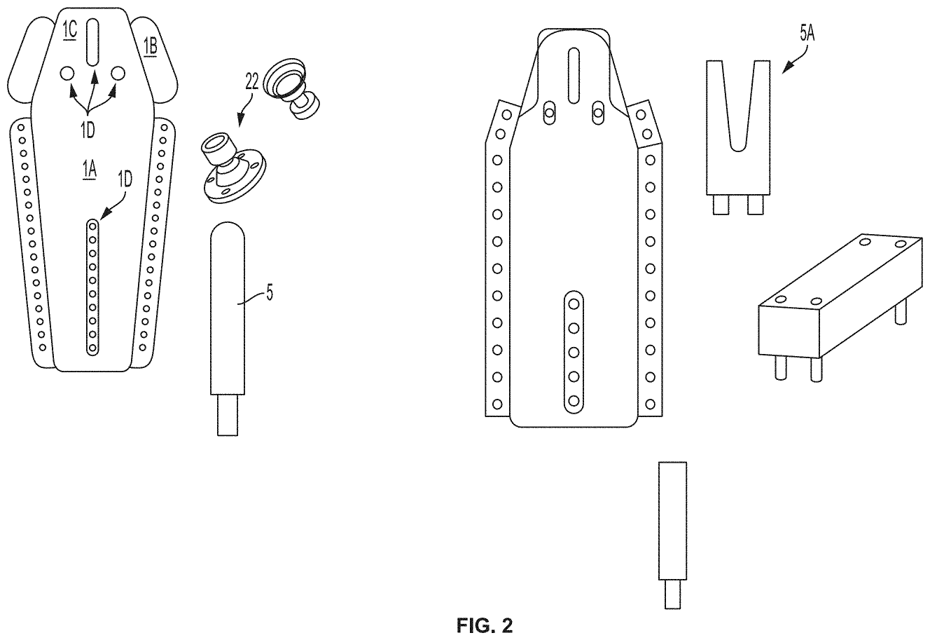

Body portion 1A of top surface 1 of FIGS. 1-2 may include a table cushion. The table cushion provides a stable and comfortable surface for the patient to lie on. The padding may be made of foam, gel, cotton, cork, or any other material that could enhance the comfort of a patient laying on top of the padding. The table cushion can be wrapped in a durable and cleanable material, such as leather, polyester, vinyl, or another protective covering to form part of body portion 1A. The table cushion can be as thin as one half inch or as thick as four inches depending on the cushioned material and its density.

The length and width of body portion 1A may be constructed to accommodate persons of any size, including persons up to (or taller than) 6′6″ tall and up to (or heavier than) 400 pounds. The width of the cushioned surface may be up to 22″. The length of the cushion may be up to 72″ in length. In other instances, the width and length of the cushion could be even larger in order to accommodate individuals greater in size.

Top surface 1 may also include arm rests 1B, as shown in FIGS. 1-2. The table arm rests 1B may be permanently attached to the table or removable. The arm rests 1B may be adjustable in height or angle. The arm rests 1B may be square, round, or oval shaped. The arm rests 1B may be constructed out of the same padding and upholstery covering as the table, or may be a different material to better provide comfort specifically to the arm of a patient.

Top surface 1 may also include head rest 1C, as shown in FIGS. 1-2, also referred to herein as a “cranial receiver”. The table head rest 1C may be permanently attached to the table or removable. The head rest 1C may be adjustable in height or angle. The head rest 1C may have an open cavity for the users face or an indentation. The head rest 1C may be constructed out of the same padding and upholstery covering as the table, or may be a different material to better provide comfort specifically to the head of a patient.

Top surface 1 may also include a recess that acts as an additional receiving hole 1D, as shown in FIGS. 1-2. There can be a recess in the cushion in a variety of places allowing for patient comfort and tool usage. Recesses may serve the purpose of navigating body appendages and landscapes like the face and major joints for patient comfort. Cushion recesses may extend partially into or completely through the cushion to the underlayment. Recesses may also provide access to the machined holes in the underlayment so stable stops and band blocks can be secured to the table.

Top surface 1 may also include a structural base 2A for top surface 1, as shown in FIGS. 1-2. The structural base 2A lies under the padding of body portion 1A and supports both the patient and the tools being used. The framework may be made of steel, aluminum, wood, plastic, or any other material which meets the weight capacity demand. Structural base 2A of top surface 1 may extend beyond the padded cover of body portion 1A. Structural base 2A may have a thickness up to four inches, but in some instances thicker, depending on the material it is made from.

Structural base 2A may include a plurality of receiving holes 2A, which may be machined cavities which receive stable stops (e.g., stable stops 5 of FIG. 1) and possible attachments for the table. Receiving holes 2B may be drilled directly into structural base 2A of the table. Receiving holes 2B may also be fashioned into tubing which fastens to structural base 2A. Receiving holes 2B may be circular, square, or oblong depending on the shape of stable stops 5 and accessories outfitted with this table. Receiving holes 2B may line the parameter of the table, the middle of the table, or staggered in a pattern across the table.

Base 4 of the table may be outfitted with wheels 10. There may be two or more wheels 10. Wheels 10 may be made of rubber, plastic, or metal. Wheels 10 may have the ability to lock. Wheels 10 may have the ability to pivot. Wheels 10 may be recessed into the table frame with a low profile such that wheels 10 only contact the ground and provide movement when an opposite end of the table is lifted in order to provide added stability when the table is in use.

Base 4 of the table may also have threaded height adjusters 11. Adjusters 11 may allow users to raise the table up off the wheels for stationary support and leveling of the table.

One of the features of the table is the table's ability to be height adjustable. The table framework may be outfitted with a scissor-style apparatus 3A which has a hinge 3B in the middle or opposing ends of the table. The table may also be outfitted with a telescopic setup with a single centered post, multiple centered posts, or multiple telescopic legs around the parameter. Any lift mechanism capable of adjusting the height of the tabletop and the top cushion may be utilized with the table described herein. The lift structure may be cylindrical tubing, square tubing, or angled bracing. The framework may be made of wood, steel, aluminum, plastic, or any other material that meets safety standards. The apparatus would allow the table to collapse to the floor for maximum portability, or to raise up to a total height of four feet, in some instances higher, for optimal comfort of the practitioner performing the tempering.

The table may raise and lower by way of a hydraulic, pneumatic, electric, or alternative motor or pump, shown in FIG. 1 as lift 3C. Lift 3C may be attached to the underside of the tabletop or to the table framework.

The operation of the lift may be controlled either manually or mechanically, such as with foot control 3D of FIG. 1. Manual lift operation may include a foot or hand pump or lever. Mechanical lift operation may include a foot or hand button, switch, wireless remote, or pedal. The operating mechanism may be attached to the table itself, lie detached from the table.

Base portion 4 of the table may contribute to its overall stability. Base portion 4 may be either a solid, plate-style structure, or a tubing structure that is bolted or welded. The plate could be made of steel, wood, or another heavy and durable material. Tubing could be round or square and of a variety of materials which meet structural integrity specifications. Base portion 4, depending on the material constructed from, could vary in length and width to accommodate the cushion tabletop.

Stable stops 5 of FIGS. 1-5 give this table the ability to balance and support Body Tempering® equipment on the patient. Stops 5 can be inserted into the table, and tools are rested against the stops so the practitioner can take his or her hands off the tools. One or more of these stable stops 5 can be fixed to the table in a variety of locations depending on where the tools need to be positioned. They may be made of rubber, wood, plastic, metal, or a compressed composite material and can have a smooth, painted, or textured finish. Stable stops 5 may range in diameter up to five inches, or in some instances more, depending on the material they are made of. The length of stable stops 5 can be a variety of lengths depending on the material they are made of and the equipment they will support. Stable stops 5 may be cylindrical, squared off with rounded edges, or squared off with sharp edges. Stable stops 5 may have protrusions or indentations to enhance the stabilization of equipment.

Stable stops 5 may also be shaped to provide support on both sides of the tempering equipment. For instance, with stable stop 5A of FIG. 2, stable stop 5A may be in a U or V shape where the tool would sit inside of stable stop 5A. They may be made of rubber, wood, plastic, metal, or a compressed composite material and can have a smooth, painted, or textured finish.

Base 31 of stable stops 5 may be machined specifically to fit into the receiver holes referenced earlier under Tabletop Base description. Base 31 of stable stops 5 may pass partially or entirely through the table. Base 31 of stable stops 5 may have an additional safety pin to secure the item to the table.

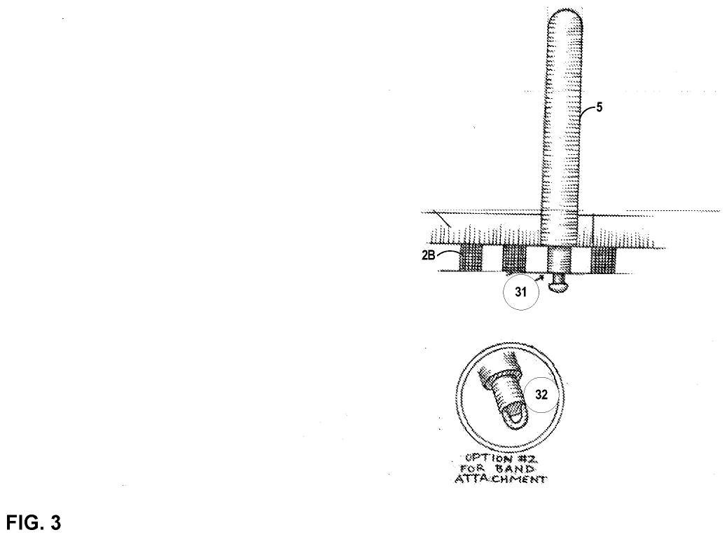

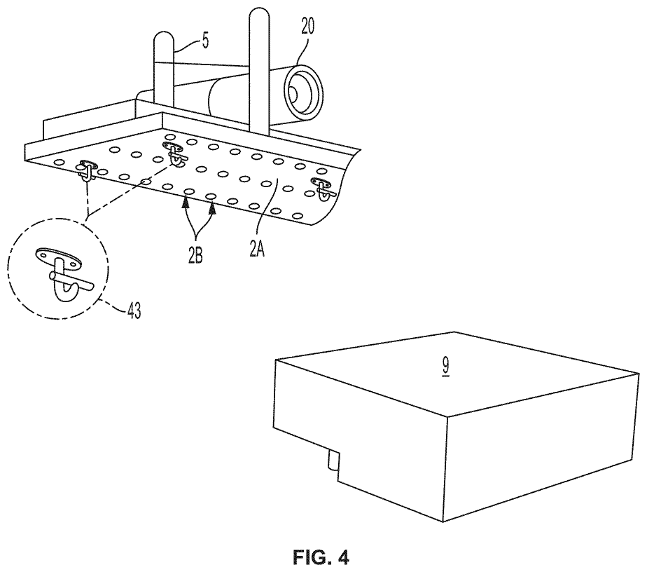

In some instances, at the base of stable stop 5 may be a resistance band or strap attachment by way of hook, clip, or lip (e.g., clip 32 of FIG. 3 or hook 43 of FIG. 4). The resistance band and strap attachments may also be fashioned on the underside of the table itself. These table attachments may be hooks, clips, or lips where bands can be fastened.

In some instances, top surface 1 may include tool receiver 12 of FIG. 1 or tool receiver 22 of FIG. 2, which allows users to anchor and leverage a variety of tools, such as a boom stick. Tool receivers 12 and 22 may be attached in a variety of spots on the tabletop surface. Tool receivers 12 and 22 may accept a variety of tools used in the tempering practice. Tool receivers 12 and 22 may offer a hinging mechanism or a 360-degree rotational swivel. Tool receivers 12 and 22 may be mounted flush or recessed into the table to allow for user comfort and effectiveness.

Band block 9 of FIGS. 1 and 4 is a removable attachment which allows the user to comfortable adjust their body position for specific scenarios. Band block 9 may have a hard, center core wrapped in a forgiving padding. The center core of band block 9 may be constructed of wood, plastic, cork, compressed foam, or metal. The wrapped padding may be made of foam, gel, cotton, or another forgiving material.

Band block 9 can be wrapped in a material durable and cleanable such as leather, polyester, vinyl, or another protective covering. Band block 9 may vary in height, width, and length to offer multiple options of body positions The underside of band block 9 may have receiver pins which fix into the machined receiver holes 2B described above in the table description.

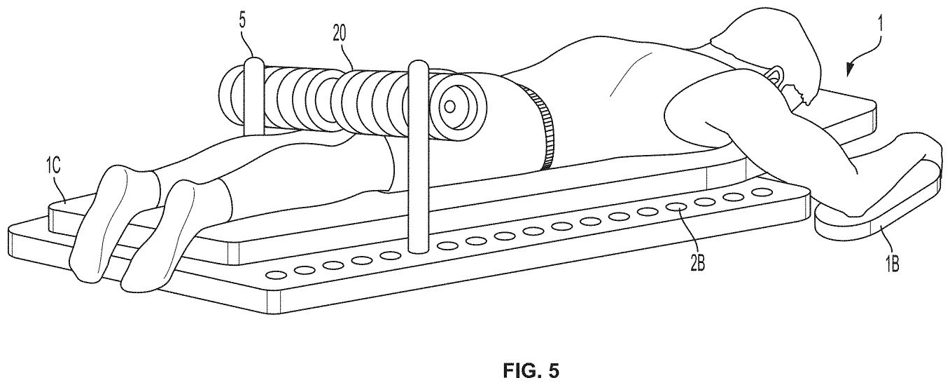

FIG. 5 is a drawing depicting a use case of a top surface 1, as described throughout this disclosure, for a patient undergoing a tempering treatment. As shown in FIG. 5, a weighted cylinder, roller 20, is placed on a particular portion of a patient undergoing the treatment. Given the natural shape of the human body, a practitioner would previously need to hold the cylinder in place to keep the weighted cylinder tool at the correct location. Utilizing the clinic table of this disclosure, once the weighted cylinder tool is placed in the correct location, stable stops 5 can be inserted into receiving holes 2B created in the sides of top surface 1 to keep the weighted cylinder tool in place without requiring human assistance.

FIG. 5 is intended to be a single example of a use case of the clinic table described herein. In other examples, the weighted cylinder tool can be placed at any point along the patient's body that is to be receiving the treatment. Similarly, the stable stops 5 can be inserted at any location along the side of the table top 1A such that the stable stops keep the weighted cylinder tool in the place desired by the practitioner, including at angles that are not perpendicular to the patient's body by placing stable stops 5 in receiving holes 2B that are not symmetrical across a center line of top surface 1. Additionally, while only two stable stops 5 are shown in FIG. 5, a practitioner may use three or more stable stops 5, such as by placing two additional stable stops 5 on the opposite side of the weighted cylinder tool in order to restrict the weighted cylinder from rolling in either direction.

Tempering is the art of relieving muscle tension by placing weighted tools on the body. After identifying all the unique properties of the clinic table for tempering described herein, this table of designed in the way described herein would expand the safety and effectiveness of this new and upcoming practice.

In accordance with this disclosure, with respect to the above figures, a temper table may include base structure 4 and top surface 1 located atop base structure 4. Top surface includes body portion 1A and a plurality of receiving holes 2B. At least a first receiving hole of the plurality of receiving holes 2B is located on a first side of the body portion, and at least a second receiving hole of the plurality of receiving holes 2B is located on a second side of the body portion opposite the first side of the body portion. The first receiving hole and the second receiving hole are at least approximately symmetrical across a center line of body portion 1A between the first side of the body portion and the second side of the body portion. For the purposes of this disclosure, approximately symmetrical may be defined as the centers of the receiving holes being symmetrical across the center line of body portion 1A with an allowance of a margin of error, such as within 2 inches.

In some instances, the first receiving hole is included in a first subgroup of receiving holes of the plurality of receiving holes 2B, and the second receiving hole is included in a second subgroup of receiving holes of the plurality of receiving holes 2B distinct from the first subgroup of receiving holes. In such instances, each receiving hole in the first subgroup of receiving holes may be at least approximately symmetrical with a corresponding receiving hole in the second subgroup of receiving holes across the center line of the body portion between the side of the body portion and the second side of the body portion. In some examples of these instances, each receiving hole in the first subgroup of receiving holes is symmetrical with the corresponding receiving hole in the second subgroup of receiving holes across the center line of the body portion between the side of the body portion and the second side of the body portion.

In some instances, a third receiving hole 1D of the plurality of receiving holes 2B is located approximately along the center line of the body portion between the first side of the body portion and the second side of the body portion. For instance, receiving hole 1D may include one or more positions to insert stable stop 5 for instances where a weighted roller is placed going vertically along a spine of the patient. In some instances, the tempering table may also include one or more boom tool receivers 12 located in the body portion of the top surface.

In some instances, the tempering table may further include cranial receiver 1C, which may be an indent along the center line of body portion 1A between the first side of the body portion and the second side of the body portion and near a third side of the body portion.

In some instances, the tempering table may further include one or more removable stable stops 5 insertable into any of the plurality receiving holes 2B. In some examples, one or more removable stable stops 5 each include a peg portion that fits into any of the plurality of receiving holes 2B and a handle portion that extends above top surface 1 of the tempering table when the peg portion is inserted into any of the plurality of receiving holes 2B. In some examples, the handle portion is a solid handle, and in other examples, the handle portion is a split handle. In some instances, one or more stable stops 5 each further include one or more of an attachment receiver attached to the peg portion such that the attachment receiver extends below top surface 1 of the tempering table when the peg portion is inserted into any of the plurality of receiving holes 2B or a pin attached to the peg portion such that the pin extends below top surface 1 of the tempering table when the peg portion is inserted into any of the plurality of receiving holes 2B, the pin securing the respective stable stop 5 to the tempering table.

In some instances, the tempering table includes an attachment receiver attached to an underside of top surface 1 of the tempering table.

In some instances, the tempering table further includes a removable band block 9 that includes one or more pegs that fit into any of the plurality of receiving holes 2B.

In some instances, base portion 4 is an adjustable base that may be one or more of a mechanical lift, an electrical lift, a hydraulic lift, and a pneumatic lift.

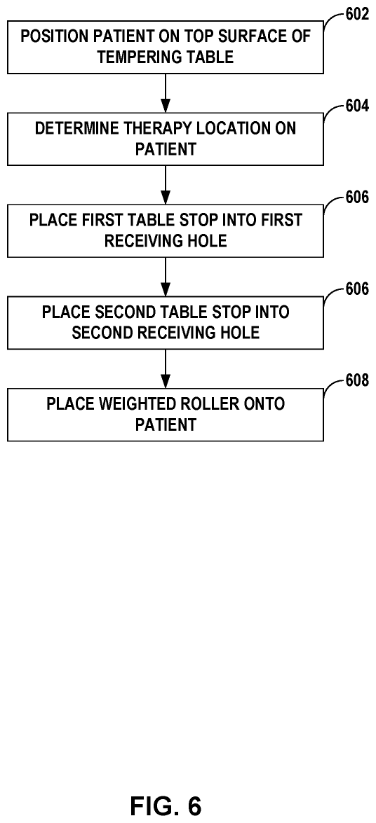

FIG. 6 is a flow chart illustrating an example mode of operation. The techniques of FIG. 6 may be performed using a tempering table as described throughout this disclosure. In accordance with the techniques described herein, a user positions a patient on a top surface of a tempering table (602). The user determines a therapy location on the patient (604). The user places a first stable stop into a first receiving hole of the tempering table on a first side of the therapy location on the patient (606). The user also places a second stable stop into a second receiving hole of the tempering table on a second side of the therapy location on the patient (608). The user then places a weighted roller onto the patient such that the first stable stop and the second stable stop keep the weighted roller in a stationary location without human assistance (610).

It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently.

Various examples of the disclosure have been described. Any combination of the described systems, operations, or functions is contemplated. These and other examples are within the scope of the following claims.

What is claimed is:

1. A tempering table comprising:
a base structure; and
a top surface located atop the base structure,
wherein the top surface comprises a body portion and a plurality of receiving holes,
wherein at least a first receiving hole of the plurality of receiving holes is located on a first side of the body portion,
wherein at least a second receiving hole of the plurality of receiving holes is located on a second side of the body portion opposite the first side of the body portion, and
wherein the first receiving hole and the second receiving hole are at least approximately symmetrical across a center line of the body portion between the first side of the body portion and the second side of the body portion.

2. The tempering table of claim 1,
wherein the first receiving hole is included in a first subgroup of receiving holes of the plurality of receiving holes,
wherein the second receiving hole is included in a second subgroup of receiving holes of the plurality of receiving holes distinct from the first subgroup of receiving holes,
and wherein each receiving hole in the first subgroup of receiving holes is at least approximately symmetrical with a corresponding receiving hole in the second subgroup of receiving holes across the center line of the body portion between the side of the body portion and the second side of the body portion.

3. The tempering table of claim 2, wherein each receiving hole in the first subgroup of receiving holes is symmetrical with the corresponding receiving hole in the second subgroup of receiving holes across the center line of the body portion between the side of the body portion and the second side of the body portion.

4. The tempering table of claim 1,
wherein a third receiving hole of the plurality of receiving holes is located approximately along the center line of the body portion between the first side of the body portion and the second side of the body portion.

5. The tempering table of claim 1, further comprising one or more boom tool receivers located in the body portion of the top surface.

6. The tempering table of claim 1, further comprising a cranial receiver comprising an indent along the center line of the body portion between the first side of the body portion and the second side of the body portion and near a third side of the body portion.

7. The tempering table of claim 1, further comprising one or more removable stable stops insertable into any of the plurality receiving holes.

8. The tempering table of claim 7, wherein the one or more removable stable stops each comprise a peg portion that fits into any of the plurality of receiving holes and a handle portion that extends above the top surface of the tempering table when the peg portion is inserted into any of the plurality of receiving holes.

9. The tempering table of claim 8, wherein the handle portion is a solid handle.

10. The tempering table of claim 8, wherein the handle portion is a split handle.

11. The tempering table of claim 8, wherein the one or more stable stops each further comprise an attachment receiver attached to the peg portion such that the attachment receiver extends below the top surface of the tempering table when the peg portion is inserted into any of the plurality of receiving holes.

12. The tempering table of claim 8, wherein the one or more stable stops each further comprise a pin attached to the peg portion such that the pin extends below the top surface of the tempering table when the peg portion is inserted into any of the plurality of receiving holes, the pin securing the respective stable stop to the tempering table.

13. The tempering table of claim 1, further comprising an attachment receiver attached to an underside of the top surface of the tempering table.

14. The tempering table of claim 1, further comprising a removable band block that comprises one or more pegs that fit into any of the plurality of receiving holes.

15. The tempering table of claim 1, wherein the base portion comprises an adjustable base comprising one or more of a mechanical lift, an electrical lift, a hydraulic lift, and a pneumatic lift.

16. The tempering table of claim 1, further comprising one or more arm rests.

17. A method for using a tempering table, the method comprising:
positioning a patient on a top surface of a tempering table;
determining a therapy location on the patient;
placing a first stable stop into a first receiving hole of the tempering table on a first side of the therapy location on the patient;
placing a second stable stop into a second receiving hole of the tempering table on a second side of the therapy location on the patient; and
placing a weighted roller onto the patient such that the first stable stop and the second stable stop keep the weighted roller in a stationary location without human assistance.

18. The method of claim 17, further comprising:
placing a third stable stop into a third receiving hold of the tempering table on the first side of the therapy location on the patient such that a space between the first stable stop and the third stable stop is approximately equal to a width of the weighted roller; and
placing a fourth stable stop into a fourth receiving hold of the tempering table on the second side of the therapy location on the patient such that a space between the second stable stop and the fourth stable stop is approximately equal to the width of the weighted roller,
wherein placing the weighted roller onto the patient comprises placing a first end of the weighted roller between the first stable stop and the second stable stop and placing a second end of the weighted roller between the second stable stop and the fourth stable stop.
